(19) United States
(12) Patent Application Publication
(10) Pub. No.: US 2007/0094643 A1
(43) Pub. Date: Apr. 26, 2007

(54) System and method for writing captured data from kernel-level to a file

(76) Inventor: Eric A. Anderson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,948

(22) Filed: Oct. 25, 2005

(51) Int. Cl. G06F 9/44

(52) U.S. Cl. 717/128

(57) ABSTRACT

According to one embodiment, a system comprises a file stored to a data storage device that is accessible to user space, and a kernel-level data capture tool, such as a kernel-level network tracing tool, that is operable to capture data and directly write the captured data to the file. According to another embodiment, a method comprises providing, by a user-space object, identification of a trace file to a kernel-level network tracing tool. The method further comprises capturing, by the kernel-level network tracing tool, data communicated over a communication network; and writing, by the kernel-level network tracing tool, at least a portion of the captured data directly to the trace file.

### FIELD OF THE INVENTION

The following description relates generally to kernel-level data capture tools, such as network tracing tools, and more specifically to systems and methods for writing captured data from kernel-level to a file.

### DESCRIPTION OF RELATED ART

Communication networks, such as the Internet and other wide-area networks (WANs), local-area networks (LANs), public- and private-switched telephony networks, and wireless networks, as examples, are widely used for communicating information. It is often desirable to perform network tracing for capturing data communicated over a network. For instance, such network tracing may be performed to capture data communicated over a network in order to analyze how the network is functioning. Based on such analysis, one may detect areas for improving the performance of the network (e.g., by eliminating unnecessary redundant data transfers, etc.).

Various kernel-level network tracing tools are known, such as tcpdump and lindump, as examples. However, such existing kernel-level network tracing tools are undesirably slow, and are unable to sufficiently capture data communicated over many high-speed networks. In an attempt to improve their capabilities, some kernel-level network tracing tools, such as tcpdump, provide options that enable a user to capture only a certain portion of the data communicated over a network, such as packet headers and/or packets matching some pattern (using a filter). This may improve the performance (i.e., speed) of the network tracing tool by sacrificing the capture of a portion of the data, i.e., if the user is willing and able to filter out of the trace much of the data that is communicated over the network. For many analyses, however, it is undesirable to sacrifice the capture of data. For example, in some instances, the information that may be of interest for analysis may not be contained in a pre-defined portion of a packet, in which case it may be desirable to capture all data by the network tracing tool in order to ensure that the information that is of interest is captured. Similarly, filtering based on packet patterns is typically a viable option only if most packets are uninteresting for a given analysis. Other situations may exist in which it is undesirable to sacrifice the capture of data in attempt to improve performance of the network tracing tool.

Accordingly, a desire exists for a high-speed network tracing tool that is capable of capturing data communicated over high-speed networks. Further, a desire exists for such a high-speed network tracing tool that does not require sacrificing capture of a portion of the data communicated over the network for achieving such high-speed.

### BRIEF DESCRIPTION OF THE DRAWINGS

For a more complete understanding of the present invention, reference is now made to the following descriptions taken in conjunction with the accompanying drawing, in which:

FIG. 1 shows an exemplary block diagram of a system implementing one embodiment of the present invention;

FIGS. 2A-2C show operational flow diagrams according to exemplary embodiments of the present invention;

FIG. 3 shows a block diagram of an exemplary system implementing a kernel-level network tracing tool according to one embodiment of the present invention;

FIGS. 4A-4B show an exemplary system and illustrate operation of one embodiment of the present invention;

FIG. 5 shows another exemplary system and illustrates operation of another embodiment of the present invention;

FIG. 6 shows a block diagram of a system that implements another embodiment of the present invention;

FIG. 7 shows an operational flow for one exemplary embodiment of the present invention, such as the exemplary system of FIG. 6; and

FIG. 8 shows a block diagram of an exemplary system according to one embodiment of the present invention.

### DETAILED DESCRIPTION

Embodiments of the present invention provide a high-speed data capture tool. As described further below, embodiments of the present invention provide a kernel-level data capture tool that is operable to write captured data directly to a file that is accessible from user space. Accordingly, certain embodiments of the present invention eliminate data copy operations that are prevalent in prior data capture tools, such as prior network tracing tools, thereby improving speed of the tool. In certain embodiments of the present invention, the high-speed data capture tool is implemented as a network tracing tool. However, while many exemplary embodiments are described herein for a network tracing tool, the concepts described herein may likewise be employed for implementing many other types of kernel-level data capture tools.

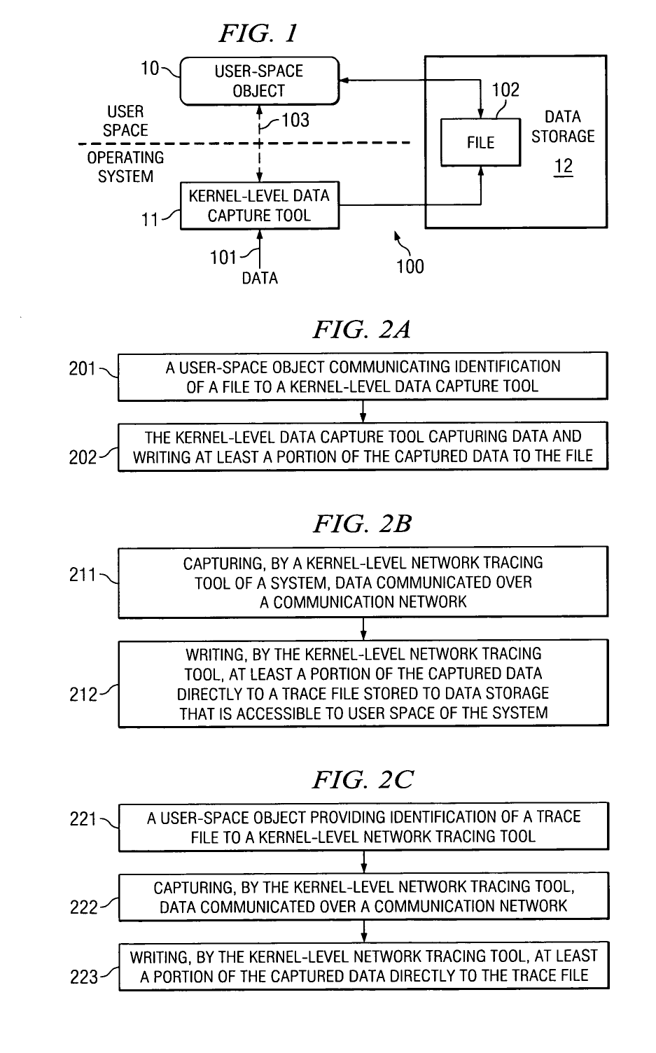

FIG. 1 shows an exemplary block diagram of a system 100 implementing one embodiment of the present invention. Exemplary system 100 comprises a user-space object 10, kernel-level data capture tool 11, and data storage device 12. In general, a system's operating system generally segregates the available system memory into kernel space and user space. The kernel space is used for running the kernel, device drivers, and any kernel extensions, while the user space is the memory area used by all user mode applications. Typically, a user application cannot access the kernel space directly, and similarly a kernel code cannot safely access the user space without checking whether the page is present in memory or swapped out to disk. Also, kernel modules can respond to interrupts directly, whereas user-space applications must wait until the interrupt is completed.

User-space object 10 may be an application program or other process executing on the system 100, as examples. Kernel-level data capture tool 11 may be implemented as computer-executable software code that is stored to a computer-readable medium (e.g., memory or other data storage mechanism). In certain embodiments, the kernel-level data capture tool 11 comprises a command-line utility, similar to tcpdump or lindump, for example. Data storage device 12 may comprise memory, disk, a file system, and/or any other mechanism that is suitable for storage of file(s) and that is accessible by user-space object 10.

In operation, kernel-level data capture tool 11 captures data 101. As described further herein, in certain embodiments kernel-level data capture tool 11 is a network tracing tool that captures data (e.g., packets) communicated over a network. According to embodiments of the present invention, kernel-level data capture tool 11 writes at least a portion of the captured data directly to file 102 in the user-space accessible data storage device 12. Thus, rather than being required to copy the captured data to a user-space program that may then write the data to a file, kernel-level data capture tool 11 is operable to write captured data directly to file 102. Thereafter, one or more user-space objects 10 may access file 102 to, for example, analyze the captured data stored therein.

In certain embodiments, user-space object 10 and kernel-level data capture tool 11 may communicatively interact via communications 103. For instance, in certain embodiments, user-space object 10 may trigger the operation of kernel-level data capture tool 11. For example, user-space object 10 may make the corresponding operating system call to invoke the kernel-level data capture tool 11 to begin capturing data. Of course, in other embodiments, kernel-level data capture tool 11 may be invoked in any other manner by user-space object 10 or any other object. In certain embodiments, user-space object 10 communicates information to kernel-level data capture tool 11 identifying file(s) 102 to which kernel-level data capture tool 11 is to write captured data. Thus, in certain embodiments, user-space object 10 may create file(s) 102 to which captured data is to be written (e.g., and user-space object 10 may define the size and/or other attributes of such file(s) 102), and then user-space object 10 may communicate identification of such file(s) 102 to kernel-level data capture tool 11. Further, in certain embodiments, kernel-level data capture tool 11 communicates to user-space object 10 to notify such user-space object 10 when a file 102 is full. Accordingly, in response to such notification the user-space object 10 may inform kernel-level data capture tool 11 of another file to which it is to write captured data.

FIGS. 2A-2C show operational flow diagrams according to exemplary embodiments of the present invention. FIG. 2A shows an operational flow for one embodiment, wherein user-space object 10 communicates identification of a file 102 to kernel-level data capture tool 11 in operational block 201. In block 202, kernel-level data capture tool 11 captures data 101 and writes at least a portion of the captured data 101 to the file 102. Thus, the data is written directly from the kernel level (via kernel-level data capture tool 11 itself) to file 102, rather than requiring the data to be written to file 102 via user-space object 10, requiring at least one extra copy.

FIG. 2B shows an operational flow for another embodiment, wherein kernel-level data capture tool 11 is employed as a network tracing tool. In operational block 211, the kernel-level network tracing tool captures data (e.g., data 101) communicated over a communication network. In block 212, the kernel-level network tracing tool writes at least a portion of the captured data directly to a trace file (e.g., file 102 of FIG. 1) stored to data storage 12 that is accessible to user space of the system. Thus, the captured network data is written directly from the kernel level (via a kernel-level network tracing tool) to a trace file, rather than requiring the data to be written to file 102 via user-space object 10.

FIG. 2C shows an operational flow for another embodiment, wherein kernel-level data capture tool 11 is again employed as a network tracing tool. In operational block 221, user-space object 10 provides identification of a trace file (e.g., file 102) to the kernel-level network tracing tool. In block 222, the kernel-level network tracing tool captures data (e.g., data 101) communicated over a communication network. In block 223, the kernel-level network tracing tool writes at least a portion of the captured data directly to the trace file. Again, the captured network data is written directly from the kernel level (via a kernel-level network tracing tool) to a trace file, rather than requiring the data to be written to file 102 via user-space object 10. In this exemplary embodiment, the kernel-level network tracing tool writes the captured network data to a trace file specified by a user-space object 10.

It should be recognized that according to embodiments of the present invention, a kernel-level data capture tool, such as a kernel-level network tracing tool, writes captured data directly from kernel-level to a file. This enables, for instance, high-speed operation that is capable of capturing data of high-speed networks. Further, embodiments of the present invention can reduce memory pressure by using fewer buffers. While specific examples for implementing a network tracing tool are described further herein, application of the concepts presented herein is not limited to network tracing tools, but such concepts for writing captured data directly from kernel-level to a file may likewise be used for many other applications, such as for processor state sampling, kernel operation logging, etc.

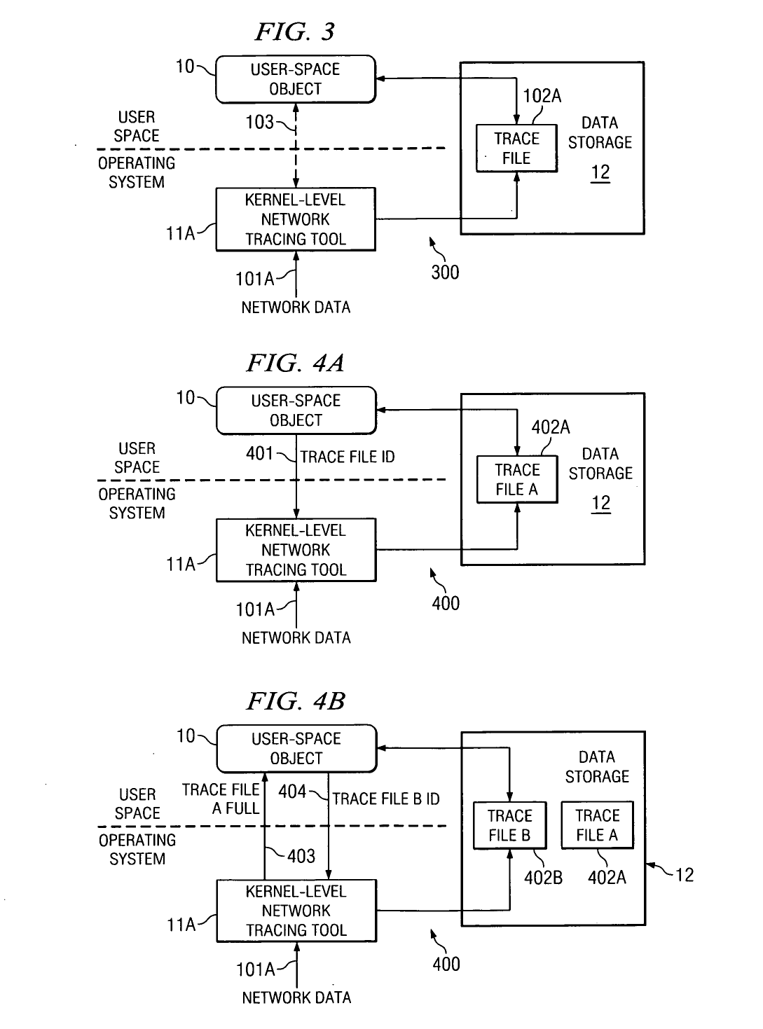

FIG. 3 shows a block diagram of an exemplary system 300 wherein kernel-level data capture tool is implemented as a kernel-level network tracing tool 11A according to one embodiment of the present invention. Kernel-level network tracing tool 11A captures data 101A communicated over a communication network (i.e., “network data”) and writes at least a portion of the captured data to a trace file 102A that is stored to data storage 12. In operation, user-space object 10 may create trace file 102A and define the size, filename, and/or other attributes of such trace file. User-space object 10 may then communicate (via communication 103) identification of the trace file 102A, such as its filename, to kernel-level network tracing tool 11A. Kernel-level network tracing tool 11A then captures network data 101A and writes at least a portion of the captured data to trace file 102A. In certain embodiments, the kernel-level network tracing tool 11A writes all of the captured data to the trace file 102A, while in other embodiments a filter may be setup (e.g., by user-space object 10) such that kernel-level network tracing tool 11A writes only a portion of the captured data 101A (e.g., packet headers, packets matching a pattern, etc.) to trace file 102A. In certain embodiments, kernel-level network tracing tool 11A notifies user-space object 10 (via communication 103) when trace file 102A is full.

Kernel-level network tracing tool 11A is highly efficient because it is capable of writing captured data directly to trace file 102A (e.g., a trace file specified by user-space object 10 in certain embodiments), rather than being required to first copy the captured data to user space (or to a shared user-space/kernel-space buffer) for a user-space object to write the data to a trace file, which requires an additional copy operation. As discussed above, prior kernel-level network tracing tools have been undesirably slow. As a result, such prior kernel-level network tracing tools are unable to capture all data communicated over many high-speed networks, and thus require a portion of the data to be sacrificed either intentionally (through filters) or unintentionally (by the tool dropping packets).

As one example, tcpdump uses various kernel features to mirror the packet stream internally in the kernel and puts the packets in a buffer which is eventually copied to user space. Tcpdump allows for filters to reduce the number of packets that are captured, and allows specification of the size of the packet to capture, but in many cases the total data throughput desired exceeds the capabilities of tcpdump. As another example, lindump, which is a linux-specific capture approach, uses memory mapping to share a ring buffer between the kernel and user space. As packets are received, they are copied into the ring buffer and then can be accessed directly at user level. Lindump also allows for packet filtering, and allows for packets to be truncated to powers of two in size. Unfortunately, these prior kernel-level network tracing tools are undesirably slow for capturing data to files at least in part because they force additional copies from the kernel to user space (e.g., to the ring buffer in the case of lindump) and then a copy to the file by user space. Additionally, such prior kernel-level network tracing tools continue to use the full network stack in the kernel for processing captured packets. As discussed further below with FIG. 8, certain embodiments of the present invention are operable to handle writing of captured packets to a file prior to the packets being processed up the kernel's network stack, and thus sending the packets up the kernel's network stack can be avoided altogether if so desired. Further, the prior kernel-level network tracing tools require greater memory bandwidth consumption than certain embodiments of the present invention. For instance, the prior techniques require a copy of captured packets to a buffer and then another copy to a file, whereas embodiments of the present invention write the captured packets directly from the kernel level to a file.

FIGS. 4A-4B show an exemplary system 400 and illustrate operation of one embodiment of the present invention. System 400 implements kernel-level network tracing tool 11A that is operable to capture network data 101A and write at least a portion of such captured data directly to a trace file. In operation of this exemplary embodiment, user-space object 10 creates trace file 402A in data storage device 12. User-space object 10 may define various attributes of trace file 402A, such as its size, filename, etc. User-space object 10 then communicates identification (e.g., filename) 401 of trace file 402A to kernel-level network tracing tool 11A. In certain embodiments, such identification may be included as part of a command made (e.g., via an operating system call, such as an ioctl) by user-space object 10 to invoke kernel-level network tracing tool 11A to begin data capture. Kernel-level network tracing tool 11A thus begins writing captured network data 101A to the specified trace file 402A.

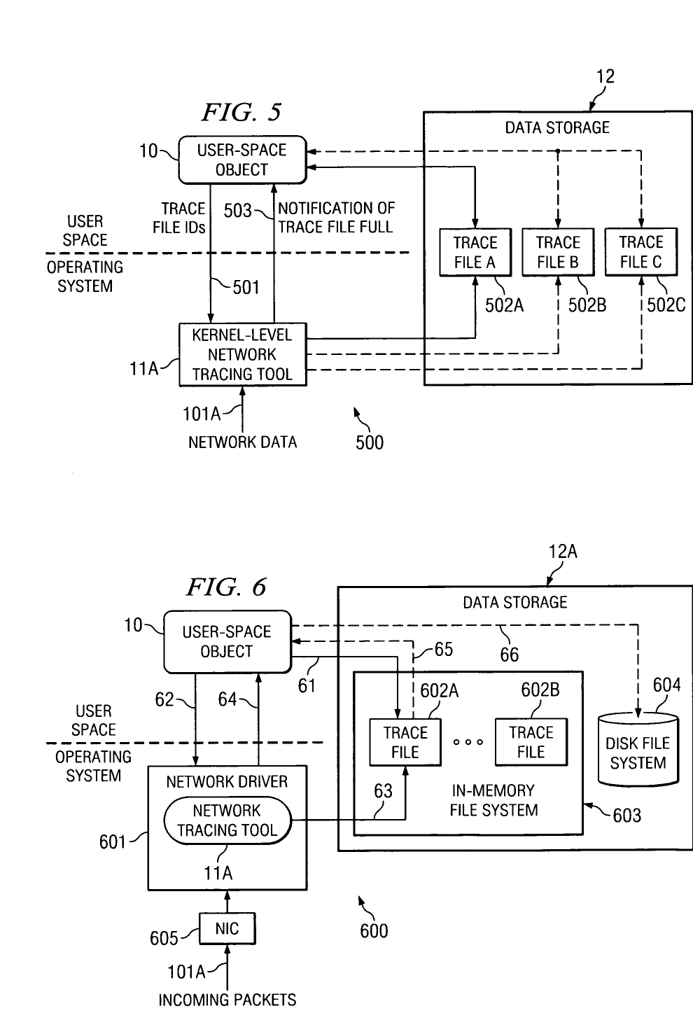

In this exemplary embodiment, kernel-level network tracing tool 11A continues writing captured network data to trace file 402A until such trace file 402A is full. As shown in FIG. 4B, when trace file 402A is full, kernel-level network tracing tool 11A notifies 403 user-space object 10. Such notification may include identifying the trace file 402A (e.g., by filename) to user-space object 10. In this exemplary embodiment, if user-space object 10 desires for kernel-level network tracing tool 11A to continue capturing network data 101A and writing captured data to a trace file, user-space object creates another trace file, trace file 402B (again defining various attributes of the trace file, such as its size, filename, etc), and communicates identification (e.g., filename) 404 of trace file 402B to kernel-level network tracing tool 11A. Of course, user-space object 10 may, in certain embodiments, create trace file 402B prior to receiving notification 403 that trace file 402A is full. Further, in certain embodiments, such as the exemplary embodiment discussed below with FIG. 5, user-space object 10 may, prior to receiving notification 403 that trace file 402A is full, inform kernel-level network tracing tool 11A of trace file 402B that is to be used once trace file 402A is full. In any case, once trace file 402A is full and kernel-level network tracing tool 11A is informed of trace file 402B, it begins writing captured network data 101A to the specified trace file 402B. User-space object 10 (or some other user-space object) may then take action regarding trace file 402A, such as compressing it and/or writing it to disk if data storage device 12 is not backed by disk, performing analysis of it, presenting information from the trace file to a user, communicating information from the trace file to another computer and/or another user-space object, etc. Once trace file 402B is full, kernel-level network tracing tool 11A notifies user-space object 10, and user-space object 10 may likewise take action regarding the trace file 402B.

FIG. 5 shows another exemplary system 500 and illustrates operation of another embodiment of the present invention. System 500 implements kernel-level network tracing tool 11A that is operable to capture network data 101A and write at least a portion of such captured data directly to a trace file. In operation of this exemplary embodiment, user-space object 10 creates a plurality of trace files 502A-502C in data storage device 12. While three trace files are shown for simplicity in this example, any number of trace files may be used in other embodiments. User-space object 10 may define various attributes of trace file 502A, such as its size, filename, etc. User-space object 10 then communicates identification (e.g., filename) 501 of the trace files 502A-502C to kernel-level network tracing tool 11A. In certain embodiments, such identification may be included as part of a command made (e.g., via an operating system call) by user-space object 10 to invoke kernel-level network tracing tool 11A to begin data capture. Kernel-level network tracing tool 11A thus begins writing captured network data 101A to a first of the specified trace files, e.g. trace file 502A. When a trace file to which the kernel-level network tracing tool 11A is writing data becomes full, the kernel-level network tracing tool 11A notifies user-space object 10 (via communication 503) and begins writing captured data to a next specified trace file, e.g. trace file 502B. When the last of the trace files identified in communication 501 is full, kernel-level network tracing tool 11A notifies user-space object 10 and stops writing captured data unless/until invoked by another call from a user-space object. Once notified that one or more of the trace files 502A-502C is/are full, user-space object 10 may take action regarding such trace file(s), such as preparing another trace file for tracing tool 11A, compressing and/or writing the file(s) to disk, performing analysis of the file(s), presenting information from the trace file(s) to a user, communicating information from the trace file(s) to another computer and/or another user-space object, etc.

FIG. 6 shows a block diagram of a system 600 that implements another embodiment of the present invention. Exemplary system 600 comprises a network driver 601 and a network interface (e.g., network interface card or “NIC”) 605. In this example, network driver 601 comprises kernel-level network tracing tool 11A. Further, in this exemplary embodiment, data storage device 12A comprises an in-memory filesystem 603 and a disk filesystem 604. In this exemplary embodiment, one or more trace files, such as trace files 602A, . . . , 602B, to which kernel-level network tracing tool 11A writes captured network data 101A is/are stored to in-memory filesystem 603.

In operation of this exemplary embodiment, user-space object 10 creates trace file 602A (and in certain embodiments further creates additional trace files, such as trace file 602B), shown as operation 61 in FIG. 6. User-space object 10 then, in operation 62, communicates identification of the trace file(s) to network driver 601. Network tracing tool 11A then writes captured network data 101A to a first specified trace file, e.g. trace file 602A, shown as operation 63 in FIG. 6. When the trace file to which the network tracing tool 11A is writing captured data is full, network tracing tool 11A notifies, via operation 64, user-space object 10. User-space object 10 may then take action on the trace file, shown as operation 65, which may include compressing and/or writing the trace file to disk filesystem 604, shown as operation 66.

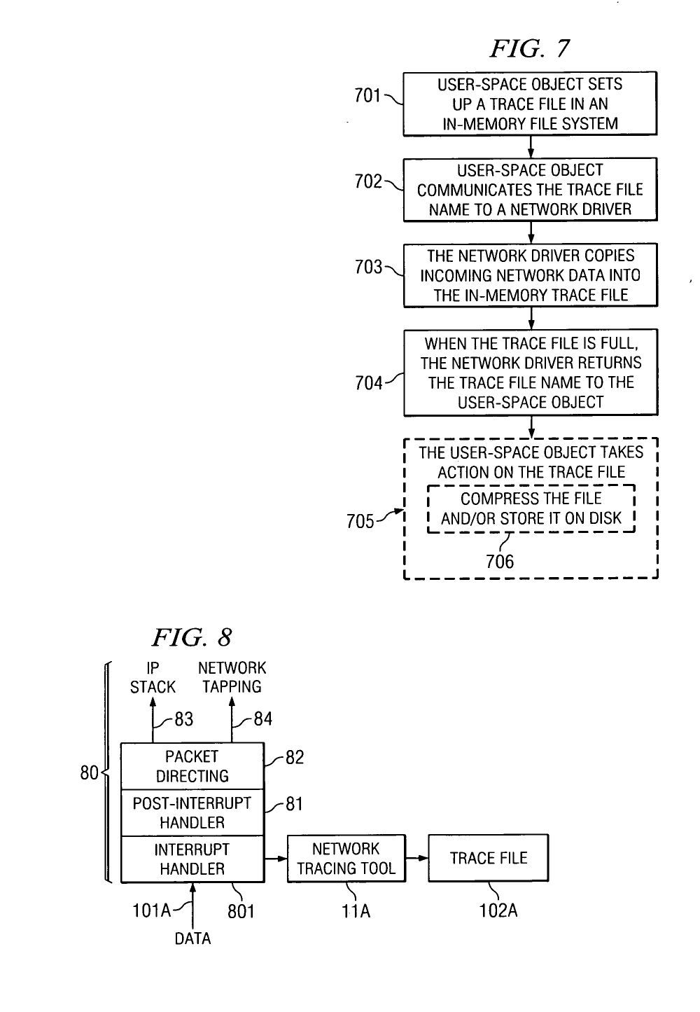

FIG. 7 shows an operational flow for one exemplary embodiment of the present invention, such as the exemplary system of FIG. 6. In operational block 701, user-space object (e.g., application program or other process) 10 sets up a trace file (e.g., trace files 602A-602B) in an in-memory file system 603. In block 702, the user-space object 10 communicates the trace file name to a network driver 601. The network driver 601 copies incoming network data (e.g., packets) 101A into the in-memory trace file, in block 703. It should be noted that this operation is different than the approach in lindump, which copies to a kernel buffer which can later be moved to a file by the user-space object. In block 704, when the trace file is full, the network driver 601 returns the trace file name to the user object 10. In certain embodiments, the user-space object may then take action on the trace file, as shown in block 705 (which is shown in dashed-line as being optional for this exemplary embodiment), such as compressing and/or storing the file to disk 604, as in sub-block 706. In certain embodiments, user-space object 10 may decide to compress the data (as in sub-block 706) if there is an available CPU, or just copy the data if there is no available CPU. Further, user-space object 10 may choose to use a slower (e.g., more compute-intensive) compression method if there are multiple available CPUs. Thus, user-space object 10 may determine action(s) to take for a trace file (in block 705) based at least in part on the processing resources that are immediately available to such user-space object 10 at the time that such user-space object 10 is handling the trace file.

Of course, various other operational flows may be formed within the scope of the present invention, wherein a kernel-level data capture tool (e.g., kernel-level network tracing tool) writes captured data directly to a file that is accessible via user space. For instance, in one embodiment, the user-space object 10 may explicitly enable network tracing, and may enable promiscuous mode on the network interface and disable it on completion. Promiscuous mode causes the NIC to receive packets addressed to other machines.

As another example, in certain embodiments, the user-space object that takes action on trace files (e.g., compressing the files, writing the files to disk, analyzing the files, etc.) may be separate from a user-space object that communicates with the kernel-level network tracing tool.

In certain embodiments, the network driver 601 is implemented to allow for packet filtering or packet truncation before copying to the in-memory trace file. Further, in certain embodiments, the kernel-level network tracing tool may be directed to write some data to different filesystems, such as in-memory filesystem 603 and disk filesystem 604. For instance, the kernel-level network tracing tool of certain embodiments may dynamically change its operation from writing captured data directly to an in-memory trace file to writing captured data directly to another portion of data storage, such as to a trace file stored to disk. The determination of whether the kernel-level network tracing tool is to write captured data to an in-memory filesystem or to a disk filesystem (or other portion of data storage) may be made (e.g., by the kernel-level network tracing tool or other logic, such as the operating system, a controller, etc.) based on some criteria, such as based on memory utilization, CPU utilization, etc, that exists at the time that the captured data is to be written. As an example, the decision as to where to write captured data may be integrated into the process of deciding whether to compress a trace file or not, wherein if the file is not compressed (e.g., because a CPU is not immediately available for performing compression) future captured data is directed to the disk filesystem 604 (directly from the kernel-level data capture tool) until a CPU is available again for performing file compression.

In certain embodiments, the network driver 601 does not pass network data 101A up the network stack. In this case, the network driver 601 may perform a copy to a trace file in an interrupt handler and recycle the packet buffer used by the NIC 605 to avoid performing memory allocation operations and the processing overhead of sending the packet up the stack. For instance, FIG. 8 shows a block diagram of an exemplary system 800 according to one embodiment of the present invention. This exemplary embodiment avoids the overhead of sending a captured packet up the network stack. Exemplary system 800 has an interrupt handler 801, which may be implemented as part of network driver 601 (FIG. 6), for instance. Interrupt handler 801 receives an interrupt, e.g. that is generated by NIC 605 (FIG. 6) when the NIC receives a packet 101A. In response to the interrupt, interrupt handler 801 causes network tracing tool 11A to write the received packet directly to trace file 102A. In one embodiment, a first portion of the network tracing tool 11A is included in the interrupt handler 801, and a second portion of the network tracing tool 11A (i.e., the part that sets up file 102A and/or starts and stops the data writing to file 102A) is included in the network driver 601.

FIG. 8 also shows network stack 80 that includes a post-interrupt handler 81 and packet directing module 82, which may direct packets up the stack to IP stack 83 and/or network tapping 84, as examples. Network tapping 84 refers to what tcpdump and lindump do, as examples. That is, network tapping 84 gets a copy of the packets (usually implemented as a pointer not as an actual copy) that is not filtered and processed by the IP stack; for example, the network tap does not check that packet checksums are correct, whereas the IP stack will drop packets with bad checksums. This exemplary embodiment can thus avoid sending the captured packets 101A up the network stack 80 by having the interrupt handler 801 trigger writing of the packet to trace file 102A. Interrupt handler 801 may be configured to not send the received packets 101A on up the stack 80, but instead causes network tracing tool 11A to write the packets to trace file 102A. In certain embodiments, captured packets are directly written (e.g., copied) from interrupt handler 801 to a trace file 102A, and standard packet processing up the kernel's network stack 80 is bypassed for such captured packets. This avoidance of processing the packets up the network stack 80 may allow the buffers for data 101A to be reused immediately, rather than allocating new buffers. Depending on the OS driver structure, network tracing tool 11A may, in certain embodiments, run as part of post-interrupt handler 81 rather than as part of interrupt handler 801 depending, for example, on where data 101A is received.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information. Thus, the exemplary operations described above as being performed by kernel-level data capture tool 11 (e.g., kernel-level network tracing tool 11A) may be implemented in a system via computer-executable software code. The software code may run on any suitable processor-based system, and the architecture of such processor-based system is of no limitation as long as it can support the novel operations described herein.

What is claimed is:

1. A system comprising:
a file stored to a data storage device that is accessible to user space; and
a kernel-level data capture tool operable to capture data and directly write the captured data to said file.

2. The system of claim 1 wherein said file is a network trace file.

3. The system of claim 1 wherein said kernel-level data capture tool comprises a kernel-level network tracing tool that is operable to capture data communicated over a communication network.

4. The system of claim 1 wherein said data storage device comprises one selected from the group consisting of memory and disk.

5. The system of claim 1 wherein said data storage device comprises a persistent data storage device.

6. The system of claim 1 further comprising:
a network stack, wherein said kernel-level data capture tool is operable to write the captured data to said file without first processing the captured data through the network stack.

7. The system of claim 1 further comprising:
a network stack, wherein said kernel-level data capture tool is operable to bypass processing the captured data through the network stack.

8. The system of claim 1 further comprising:
a network interface for receiving said data; and
a network driver that comprises said kernel-level data capture tool.

9. The system of claim 1 further comprising:
an interrupt handler that is operable to receive an interrupt for said captured data and trigger the write of the captured data directly to said file.

10. The system of claim 9 further comprising:
a network stack, wherein said interrupt handler is operable to bypass processing the captured data through the network stack.

11. The system of claim 1 wherein said kernel-level data capture tool is operable to receive information identifying said file to which said kernel-level data capture tool is to write the captured data.

12. The system of claim 1 further comprising:
a user-space object operable to communicate to said kernel-level data capture tool information identifying said file to which said kernel-level data capture tool is to write the captured data.

13. The system of claim 12 wherein said user-space object is operable to create said file.

14. The system of claim 12 wherein said kernel-level data capture tool is operable to communicate notification to said user-space object when said file becomes full.

15. The system of claim 1 wherein said kernel-level data capture tool is operable to write a portion of said captured data directly to an in-memory file and write a portion of said captured data directly to a file stored to disk.

16. The system of claim 15 wherein said kernel-level data capture tool dynamically determines whether to write said captured data to said in-memory file or to said file stored to disk based at least in part on a predetermined criteria.

17. The system of claim 16 wherein said predetermined criteria comprises at least one selected from the group consisting of:
memory utilization, CPU utilization, and whether said captured data is to be compressed before said write.

18. The system of claim 17 wherein whether said captured data is to be compressed before said write is determined at least in part on availability of a CPU for performing compression of said captured data.

19. A method comprising:
a user-space object communicating identification of a file to a kernel-level data capture tool; and
said kernel-level data capture tool capturing data and writing at least a portion of the captured data to said file.

20. The method of claim 19 further comprising:
said user-space object creating said file.

21. The method of claim 19 wherein said kernel-level data capture tool comprises a network tracing tool, and wherein said capturing data comprises:
capturing data communicated over a communication network.

22. The method of claim 21 wherein said data comprises packets.

23. The method of claim 19 further comprising:
said kernel-level data capture tool writing said at least a portion of the captured data to said file without first processing the captured data through a kernel-level network stack.

24. The method of claim 19 further comprising:
said kernel-level data capture tool bypassing processing of the captured data through a kernel-level network stack.

25. The method of claim 19 further comprising:
said kernel-level data capture tool determining whether to write said captured data to an in-memory file or to a file stored to disk based at least in part on a predetermined criteria.

26. The method of claim 25 wherein said predetermined criteria comprises at least one selected from the group consisting of:
memory utilization, CPU utilization, and whether said captured data is to be compressed before said write.

27. The system of claim 26 wherein whether said captured data is to be compressed before said write is determined at least in part on availability of a CPU for performing compression of said captured data.

28. A method comprising:
capturing, by a kernel-level network tracing tool of a system, data communicated over a communication network; and
writing, by said kernel-level network tracing tool, at least a portion of the captured data directly to a trace file stored to data storage that is accessible to user space of said system.

29. The method of claim 28 further comprising:
a user-space object communicating identification of said file to said kernel-level network tracing tool.

30. The method of claim 29 further comprising:
said user-space object creating said file.

31. The method of claim 28 further comprising:
said kernel-level network tracing tool performing said writing without first processing the captured data through a kernel-level network stack.

32. The method of claim 28 further comprising:
said kernel-level network tracing tool bypassing processing of the captured data through a kernel-level network stack.

33. A method comprising:
providing, by a user-space object, identification of a trace file to a kernel-level network tracing tool;
capturing, by said kernel-level network tracing tool, data communicated over a communication network; and
writing, by said kernel-level network tracing tool, at least a portion of the captured data directly to said trace file.

34. The method of claim 33 further comprising:
creating said trace file by said user-space object.

35. The method of claim 33 further comprising:
storing said trace file to data storage that is communicatively accessible by said user-space object.

36. The method of claim 35 wherein said data storage comprises an in-memory file system.

37. The method of claim 36 further comprising:
said user-space object writing said trace file to disk.

38. The method of claim 37 further comprising:
said user-space object receiving notification from said kernel-level network tracing tool when the trace file is full, and said user-space object performing said writing said trace file to disk responsive to receiving said notification that the trace file is full.

39. The method of claim 33 further comprising:
said user-space object compressing said trace file.

40. The method of claim 33 wherein said identification comprises the trace file's name.

41. The method of claim 33 further comprising:
when the trace file is full, the kernel-level network tracing tool returning identification of the full trace file to said user-space object.

42. Computer-executable software code for a kernel-level network tracing tool, the computer-executable software code stored to a computer-readable medium, the computer-executable software code comprising:
code for receiving, by said kernel-level network tracing tool, identification of a trace file;
code for capturing, by said kernel-level network tracing tool, data communicated over a communication network; and
code for writing, by said kernel-level network tracing tool, at least a portion of the captured data directly to the identified trace file.

43. The computer-executable software code of claim 42 wherein said code for receiving comprises:
code for receiving said identification of said trace file from a user-space object.

44. The computer-executable software code of claim 42 further comprising:
code for determining, by said kernel-level network tracing tool, when the identified trace file is full.

45. The computer-executable software code of claim 44 further comprising:
code for notifying, by the kernel-level network tracing tool, a user-space object when the identified trace file is full.
